(19) United States
(12) Patent Application Publication
(10) Pub. No.: US 2026/0058367 A1
(43) Pub. Date: Feb. 26, 2026

(54) ELECTRONIC DEVICE

(71) Applicant: PEGATRON CORPORATION, TAIPEI CITY (TW)

(72) Inventors: Chih-Wei Liao, Taipei City (TW); Chao-Hsu Wu, Taipei City (TW); Hao-Hsiang Yang, Taipei City (TW); Sheng-Chin Hsu, Taipei City (TW)

(73) Assignee: PEGATRON CORPORATION, TAIPEI CITY (TW)

(21) Appl. No.: 19/215,347

(22) Filed: May 22, 2025

(30) Foreign Application Priority Data
Aug. 23, 2024 (TW) 113131849

(51) Int. Cl. H01Q 5/35; H01Q 1/22; H01Q 1/36; H01Q 1/48; H01Q 1/52

(52) U.S. Cl. CPC H01Q 5/35; H01Q 1/36; H01Q 1/48; H01Q 1/523; H01Q 1/22

(57) ABSTRACT

An electronic device includes at least one antenna assembly. Each of the at least one antenna assembly includes a substrate, two first radiators, a decoupling element, a second radiator, and a ground plane. The substrate has a first surface and a second surface opposite to each other. The two first radiators are disposed on the first surface, each of the first radiators includes a first feed end, and each of the first radiators is adapted to operate in a high frequency band. The decoupling element is disposed on the first surface, is located between the two first radiators, and has a first slot with each of the first radiators. The second radiator is disposed on the second surface, includes a second feed end, and is adapted to operate in a low frequency band and a medium frequency band. The ground plane is disposed on the second surface.

### CROSS-REFERENCE TO RELATED APPLICATION

This application claims the priority benefit of Taiwan application serial no. 113131849, filed on Aug. 23, 2024. The entirety of the above-mentioned patent application is hereby incorporated by reference herein and made a part of this specification.

### BACKGROUND

### Technical Field

The disclosure relates to an electronic device, and more particularly to an electronic device having an antenna.

### Description of Related Art

With the advancement of technology, the size of electronic devices has been reduced. How to use a small space to design a multi-band antenna has become a research direction in the art.

### SUMMARY

The disclosure provides an electronic device with an antenna assembly that has a small size and can provide multi-band effects.

An electronic device of the disclosure includes at least one antenna assembly. Each of the at least one antenna assembly includes a substrate, two first radiators, a decoupling element, a second radiator, and a ground plane. The substrate has a first surface and a second surface opposite to each other. The two first radiators are disposed on the first surface, each of the first radiators includes a first feed end, and each of the first radiators is adapted to operate in a high frequency band. The decoupling element is disposed on the first surface, is located between the two first radiators, and has a first slot with each of the first radiators. The second radiator is disposed on the second surface, includes a second feed end, and is adapted to operate in a low frequency band and a medium frequency band. The ground plane is disposed on the second surface.

Based on the above, the antenna assembly of the electronic device of the disclosure has a small size and can provide multi-band effects by the above configuration.

### BRIEF DESCRIPTION OF THE DRAWINGS

FIG. 1 is a schematic diagram of an electronic device according to an embodiment of the disclosure.

FIG. 2 is a schematic diagram of an antenna assembly of the electronic device of FIG. 1.

FIG. 3 is a schematic diagram of a substrate, two first radiators, and a decoupling element of FIG. 2.

FIG. 4 is a schematic diagram of the substrate and a second radiator of FIG. 2.

FIG. 5A is a frequency-VSWR relationship diagram of whether two antenna assemblies in left and right temples of the electronic device of FIG. 1 lack the decoupling element.

FIG. 5B is a frequency-VSWR relationship diagram of the second radiator of FIG. 2.

FIG. 6 is a frequency-isolation relationship diagram of whether the two antenna assemblies in the left and right temples of the electronic device of FIG. 1 lack the decoupling element.

FIG. 7 is a frequency-antenna efficiency relationship diagram of the electronic device of FIG. 1 when the two antenna assemblies in the left and right temples are at medium frequencies and high frequencies.

FIG. 8 is a frequency-antenna efficiency relationship diagram of the electronic device of FIG. 1 when the two antenna assemblies in the left and right temples are at low frequencies.

FIG. 9 is a schematic diagram of a substrate, two first radiators, and a decoupling element of an antenna assembly according to another embodiment of the disclosure.

FIG. 10 is a schematic diagram of the substrate and a second radiator of the antenna assembly of FIG. 9.

FIG. 11 is a frequency-VSWR relationship diagram of the electronic device of FIG. 1 adopting the antenna assemblies of FIG. 9 and FIG. 10 in left and right temples.

FIG. 12 is a frequency-antenna efficiency relationship diagram of the electronic device of FIG. 1 adopting the antenna assemblies of FIG. 9 and FIG. 10 in the left and right temples.

FIG. 13 is a schematic diagram of an electronic device according to another embodiment of the disclosure.

### DESCRIPTION OF THE EMBODIMENTS

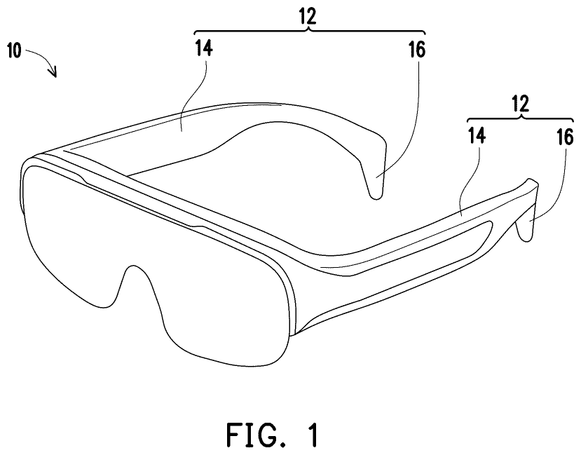

FIG. 1 is a schematic diagram of an electronic device according to an embodiment of the disclosure. Please refer to FIG. 1. An electronic device 10 of the embodiment includes at least one antenna assembly 100. Specifically, the electronic device 10 is glasses, such as augmented reality (AR) glasses or virtual reality (VR) glasses, but the type of the electronic device 10 is not limited thereto.

The electronic device 10 includes two temples 12. Each of the two temples 12 includes a crossbar area 14 and an ear hook area 16. In the embodiment, the number of the antenna assemblies 100 is two. Each of the two antenna assemblies 100 is disposed in the crossbar area 14 and the ear hook area 16 of one of the temples 12 to be applied in a considerably small space of the electronic device 10.

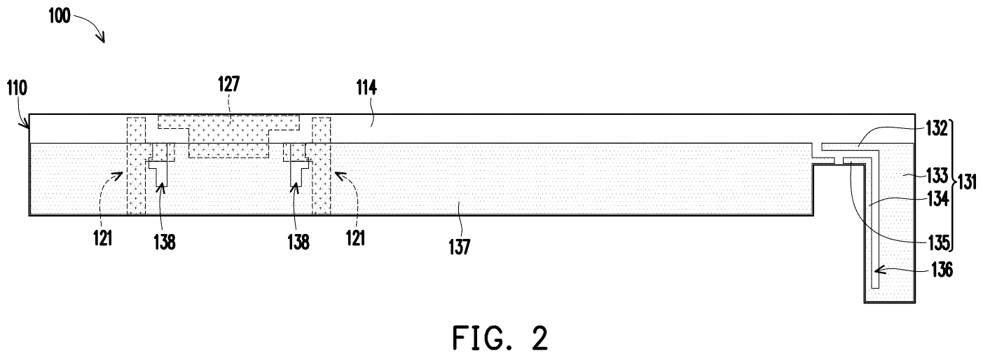

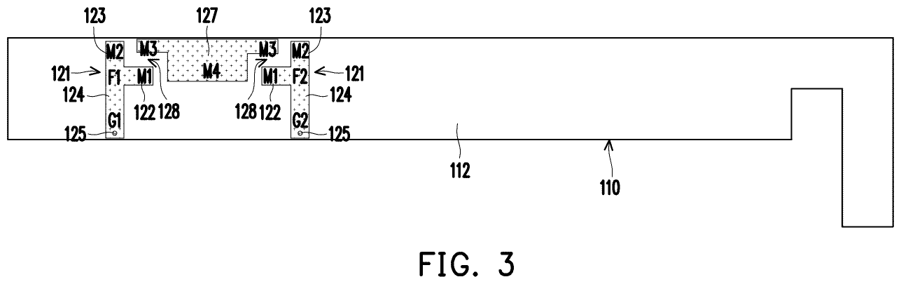

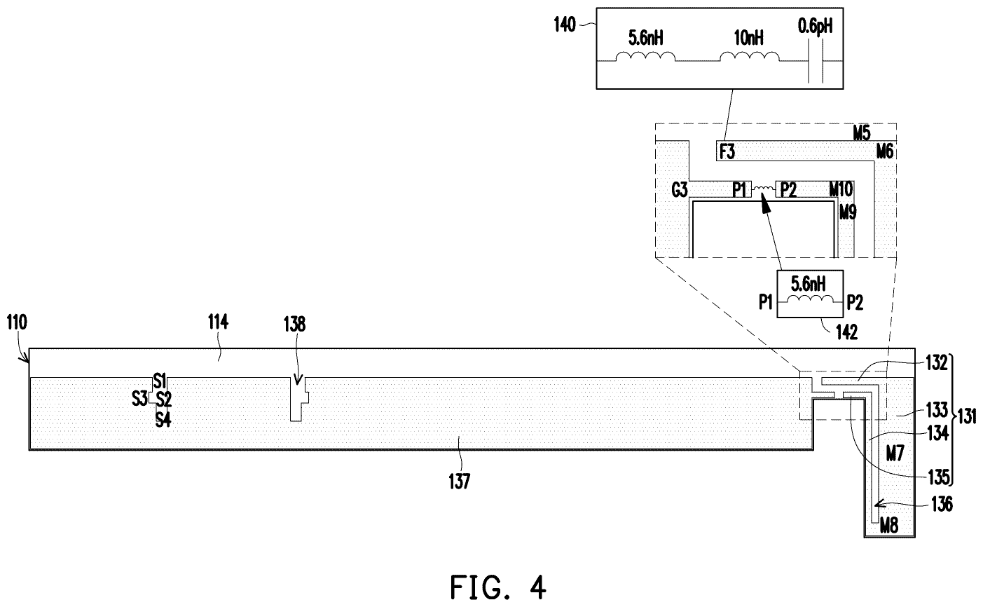

FIG. 2 is a schematic diagram of an antenna assembly of the electronic device of FIG. 1. FIG. 3 is a schematic diagram of a substrate, two first radiators, and a decoupling element of FIG. 2. FIG. 4 is a schematic diagram of the substrate and a second radiator of FIG. 2. It should be noted that in FIG. 2, since the two first radiators and the decoupling element and the second radiator are not on the same plane, the two first radiators and the decoupling element are represented by dotted lines.

Please refer to FIG. 2 to FIG. 4. Each antenna assembly 100 includes a substrate 110, two first radiators 121, a decoupling element 127, a second radiator 131, and a ground plane 137. The substrate 110 has a first surface 112 (FIG. 3) and a second surface 114 (FIG. 4) opposite to each other. As shown in FIG. 2, in the embodiment, projections of the two first radiators 121, the decoupling element 127, the second radiator 131, and the ground plane 137 onto the second surface 114 on the substrate 110 at least partially overlap, so that the antenna assembly 100 may have a smaller size.

As shown in FIG. 3, the two first radiators 121 and the decoupling element 127 are disposed on the first surface 112 of the substrate 110. The first radiator 121 on the left of FIG. 3 includes a first feed end F1, and the first radiator 121 on the right of FIG. 3 includes a first feed end F2. The two first radiators 121 are symmetrically located on two sides of the decoupling element 127.

As shown in FIG. 4, the second radiator 131 is disposed on the second surface 114 and includes a second feed end F3. The ground plane 137 is disposed on the second surface 114 and is connected to the second radiator 131. As shown in FIG. 2, the projections of the two first radiators 121 and the decoupling element 127 onto the second surface 114 partially overlap on the ground plane 137.

In the embodiment, the two first radiators 121, the decoupling element 127, and the ground plane 137 of each antenna assembly 100 are located in the crossbar area 14 of the corresponding temple 12, and the second radiator 131 is located in the ear hook area 16 of the corresponding temple 12 to be applied in considerably small spaces of the temples 112.

Please return to FIG. 3. Each of the two first radiators 121 includes a first section 122, a second section 123, and a third section 124. The first section 122 extends from the first feed end F1 or F2 toward the direction of the other first radiator 121, and the second section 123 and the third section 124 extend toward opposite directions. In the embodiment, the second section 123 extends upward from the first feed end F1 or F2, and the third section 124 extends downward from the first feed end F1 or F2.

The third section 124 has a first ground end G1 or G2. The first ground end G1 or G2 of the first radiator 121 is conducted to the ground plane 137 through a via 125 penetrating the substrate 110 and is lapped with a metal frame of the temple 12 (the ground plane 137 of the system). In other words, the two first radiators 121 and the second radiator 131 share the ground plane 137. Such a design may save the space occupied by the antenna assembly 100 in the temple 12.

The decoupling element 127 is disposed between the two first radiators 121 and may reduce a mutual coupling energy between the two first radiators 121. There are two first slots 128 between the two first radiators 121 and the decoupling element 127.

Specifically, in the embodiment, an outer contour of the decoupling element 127 corresponds to an outer contour of the first section 122 and the second section 123 of each of the two first radiators 121, so that the first slot 128 is formed between the decoupling element 127 and the corresponding first section 122 and second section 123.

The length and the width of the decoupling element 127 at positions M3 and M4 may control the length and the width of the first slot 128 to increase isolation between the two first radiators 121 and improve impedance matching of the first radiators 121.

In the embodiment, the widths of the two first slots 128 are the same, and the widths of the two first slots 128 are between 0.8 mm and 2 mm, such as 1 mm, but not limited thereto.

Two positive ends of two coaxial transmission lines (not shown) are respectively connected to the first feed ends F1 and F2, and two negative ends of the two coaxial transmission lines are respectively connected to the first ground ends G1 and G2. In the embodiment, the two coaxial transmission lines connected to the two first radiators 121 do not need to be connected to an additional matching circuit, thereby saving cost and space.

As shown in FIG. 4, the ground plane 137 includes two second slots 138. The projection of each of the two first slots 128 onto the second surface 114 partially overlaps with the corresponding second slot 138. In the embodiment, each second slot 138 includes vertical sections at positions S1, S2, and S4 and horizontal sections extending from positions S2 and S3 toward a direction away from the other second slot 138. Each of the two second slots 138 is recessed from the edge of the ground plane 137 at the position S1, and the two first radiators 121 are in two T-shapes opposite to each other.

In the embodiment, the length of the first section 122 (that is, from the first feed end F1 or F2 to a position M1) is 2.5 mm, but not limited thereto. A signal of the first radiator 121 is coupled from the first feed end F1 or F2 and the position M1 to the second slot 138 to couple out a high frequency band.

In the embodiment, the high frequency band is, for example, between 3300 MHz and 5000 MHz, and is synthesized by a first mode and a second mode of ultra high bandwidth (UHB). Adjusting the length of the second slot 138 may adjust resonant frequency points of the first mode and the second mode of UHB, and adjusting the width of the second slot 138 may adjust an impedance matching bandwidth of the first mode of UHB. In addition, adjusting the length of the second section 123 (from the first feed end F1 or F2 to a position M2) may adjust an impedance matching bandwidth of the second mode of UHB. In the embodiment, the length of the second section 123 (from the first feed end F1 or F2 to the position M2) is 3.5 mm, but not limited thereto.

In the embodiment, the minimum distance between the two second slots 138 is greater than 17 mm. Such a design may reduce coupling between the two first radiators 121 to improve the isolation between the two first radiators 121. In the embodiment, the vertical length of the second slot 138 at the positions S1, S2, and S4 is 6 mm, and the horizontal length of the second slot 138 at the positions S2 and S3 is 2.5 mm, but not limited thereto. In addition, each of the two second slots 138 has a single width, but not limited thereto.

In the embodiment, the size of the two first radiators 121 is, for example, 28 mm×14.5 mm×0.8 mm, presenting a low profile and saving considerable space. The two first radiators 121 may couple out the high frequency band and form a broadband antenna characteristic without adding a tuning switching circuit.

On the other hand, please refer to FIG. 4. In the embodiment, the second radiator 131 includes a fifth section 132 (from the second feed end F3 to positions M5 and M6), a sixth section 133 (at positions M6 to M8), a seventh section 134 (at positions M8 and M9), and an eighth section 135 (from positions M9, M10, P2, and P1 to a second ground end G3) which are sequentially bendingly connected.

The eighth section 135 is parallel to the fifth section 132, and the sixth section 133 is parallel to the seventh section 134 to form an L-shaped slot 136. The width of the L-shaped slot 136 is 1 mm. In the embodiment, the fifth section 132 and the eighth section 135 are disposed on the second surface 114 of the substrate 110, and the sixth section 133 and the seventh section 134 may be selectively formed by an insert molded metal member. The width of the metal member at a position M7 is 4 mm. Of course, in an embodiment, the sixth section 133 and the seventh section 134 may also be formed on the second surface 114 of the substrate 110.

The second feed end F3 is located in the fifth section 132 and is close to the ground plane 137. Each antenna assembly 100 includes a matching circuit 140. The matching circuit 140 includes, for example, a series capacitor of 0.6 pF, a series inductor of 10 nH, and a series inductor of 5.6 nH, but not limited thereto. The matching circuit 140 is connected to the second feed end F3.

In addition, the eighth section 135 is connected to the ground plane 137 through the second ground end G3. In the embodiment, the eighth section 135 is provided with an inductance element 142 between the positions P1 and P2 to extend a current path. The inductance element 142 is, for example, a series inductor of 2.7 nH, but not limited thereto.

A positive end of another coaxial transmission line (not shown) is connected to the second feed end F3 via the matching circuit 140, and a negative end of the coaxial transmission line is connected to the second ground end G3 and is lapped with the metal frame of the temple 12 (the ground plane 137 of the system).

The second radiator 131 couples out a low frequency band and a medium frequency band. The low frequency band is, for example, LB (698 MHz to 960 MHz), and the medium frequency band is, for example, MHB (1710 MHz to 2690 MHz) as the second mode. The two modes are synthesized into a dual-band antenna characteristic.

With the above design, the size of the second radiator 131 is 21 mm×13.5 mm×0.8 mm, saving considerable space. In addition, the second radiator 131 may form a 5G NR Sub-6 LB and MHB dual-band antenna architecture without adding a tuning switching circuit.

Therefore, the electronic device 10 of the embodiment is provided with the antenna assembly 100 including the two first radiators 121, the decoupling element 127, and the second radiator 131 at the temple 12 to form a full-band multi-antenna design.

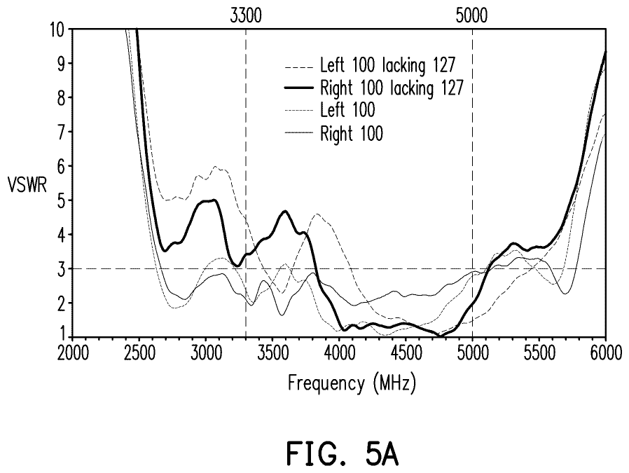

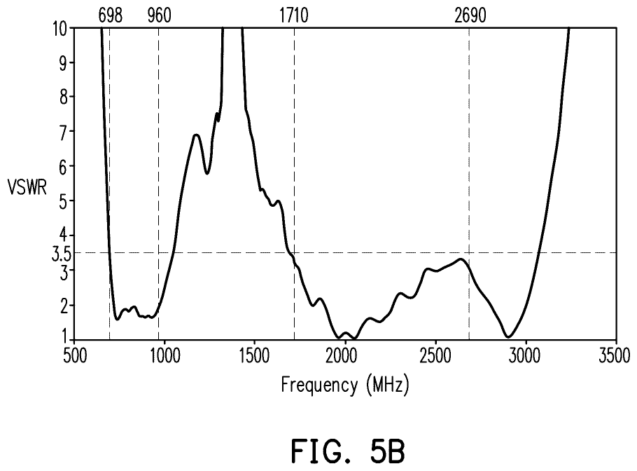

FIG. 5A is a frequency-VSWR relationship diagram of whether two antenna assemblies in left and right temples of the electronic device of FIG. 1 lack the decoupling element. Please refer to FIG. 5A. FIG. 5A shows the frequency-VSWR relationship diagram of the antenna assembly 100 (having the decoupling element 127) in the left temple 12, the antenna assembly 100 (having the decoupling element 127) in the right temple 12, an antenna assembly lacking the decoupling element 127 in the left temple 12, and an antenna assembly lacking the decoupling element 127 in the right temple 12.

As can be seen from FIG. 5A, voltage standing wave ratios (VSWR) of the antenna assembly 100 in the left temple 12 and the antenna assembly 100 in the right temple 12 having the decoupling element 127 in the high frequency band (3300 MHz to 5000 MHz) may all be below 3 to have a good performance.

FIG. 5B is a frequency-VSWR relationship diagram of the second radiator of FIG. 2. Please refer to FIG. 5B. VSWRs of the second radiator 131 in the low frequency band (698 MHz to 960 MHz) and the medium frequency band (1710 MHz to 2690 MHz) may all be below 3.5 to have a good performance.

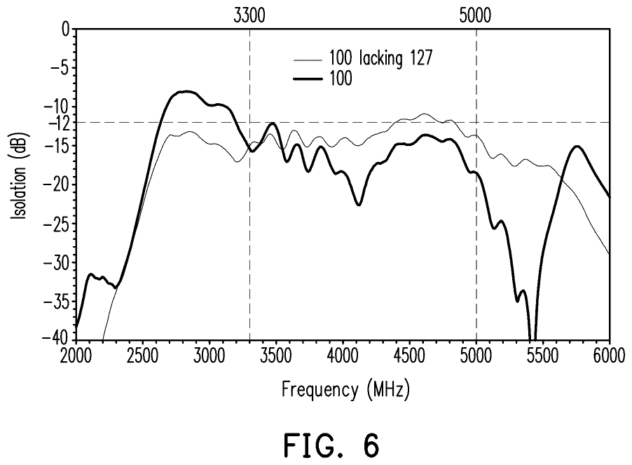

FIG. 6 is a frequency-isolation relationship diagram of whether the two antenna assemblies in the left and right temples of the electronic device of FIG. 1 lack the decoupling element. Please refer to FIG. 6. FIG. 6 shows the frequency-isolation relationship between the two antenna assemblies 100 (having the decoupling elements 127) in the two temples 12 and the frequency-isolation relationship between the two antenna assemblies without the decoupling elements 127 in the two temples 12.

In the embodiment, since a distance between the two second slots 138 of each antenna assembly 100 is 17 mm, which is a sufficient distance, there is a good isolation performance of less than −12 dB. In addition, the isolation of the antenna assembly 100 having the decoupling element 127 may be better.

In addition, through tests, the antenna assembly 100 having the decoupling element 127 also has improved impedance matching in the frequency band of 3300 MHz to 3800 MHz, and an envelope correlation coefficient (ECC) is below 0.1 to have a good performance.

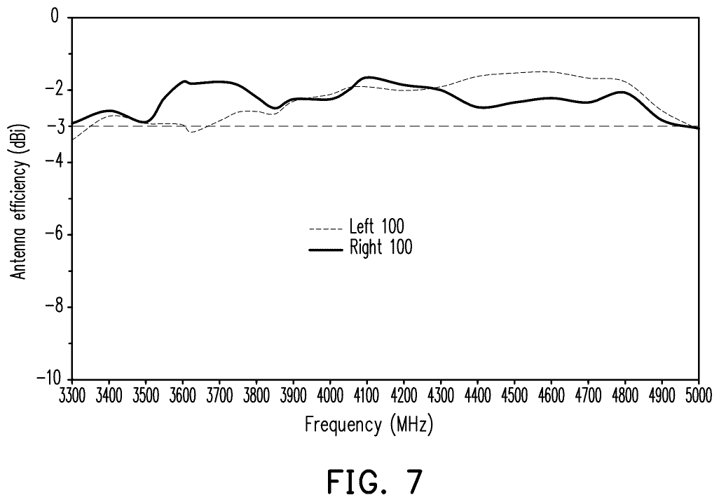

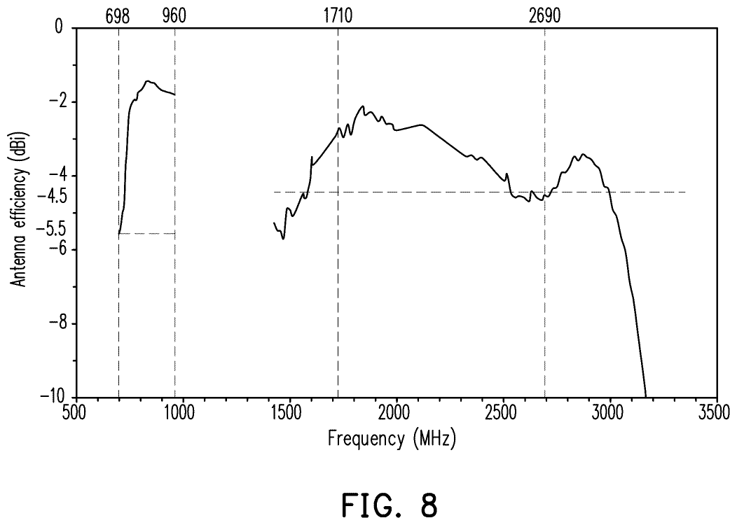

FIG. 7 is a frequency-antenna efficiency relationship diagram of the electronic device of FIG. 1 when the two antenna assemblies in the left and right temples are at medium frequencies and high frequencies. FIG. 8 is a frequency-antenna efficiency relationship diagram of the electronic device of FIG. 1 when the two antenna assemblies in the left and right temples are at low frequencies.

Please refer to FIG. 7 and FIG. 8. Each of the antenna assembly 100 in the left temple 12 and the antenna assembly 100 in the right temple 12 has an antenna efficiency of −1.5 dBi to −3.3 dBi in the high frequency band (3300 MHz to 5000 MHz), an antenna efficiency of −1.4 dBi to −5.5 dBi in the low frequency band (698 MHz to 960 MHz), and an antenna efficiency of −2.1 dBi to −4.6 dBi in the medium frequency band (1710 MHz to 2690 MHz) to have a good antenna performance.

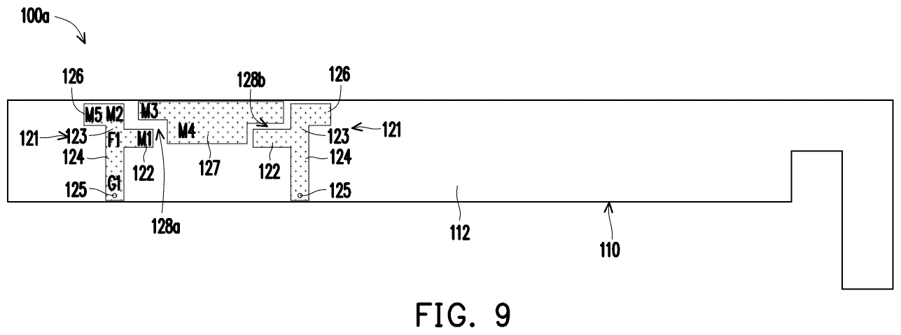

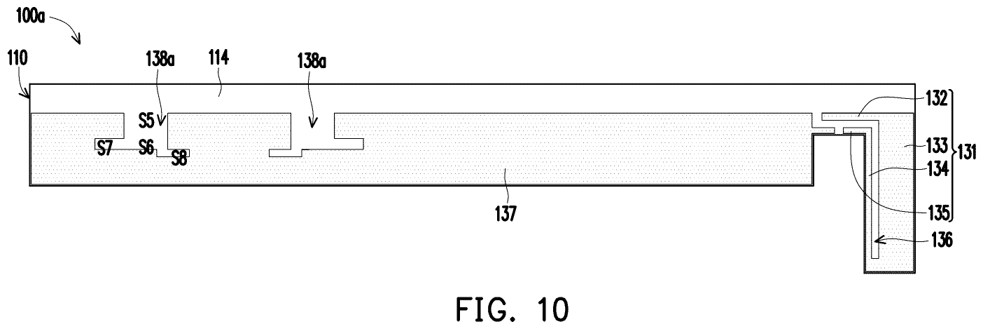

FIG. 9 is a schematic diagram of a substrate, two first radiators, and a decoupling element of an antenna assembly according to another embodiment of the disclosure. FIG. 10 is a schematic diagram of the substrate and a second radiator of the antenna assembly of FIG. 9.

It should be noted that the two first radiators 121, the decoupling element 127, and the second radiator 131 of FIG. 9 and FIG. 10 are disposed on the first surface 112 and the second surface 114 of the substrate 110 as shown in FIG. 2 and partially overlap. Only the structure of a single side of the substrate 110 is shown below, only the main difference from FIG. 3 and FIG. 4 pointed out, and the same or similar parts are not repeated.

Please refer to FIG. 9. In the embodiment, each of the two first radiators 121 of an antenna assembly 100a further includes a fourth section 126 (at positions M2 and N5). The fourth section 126 extends from the second section 123 toward a direction away from the other first radiator 121.

In addition, in the embodiment, the widths of two first slots 128a and 128b are between 0.8 mm and 2 mm, and the widths of the two first slots 128a and 128b are different. Specifically, in FIG. 10, since an area of the ground plane 137 on the right side of the second slot 138 on the right is greater than an area of the ground plane 137 on the left side of the second slot 138 on the left. In the embodiment, the width of the first slot 128a on the left of FIG. 9 is designed to be greater, such as 1.3 mm to 2 mm. The width of the first slot 128b on the right of FIG. 9 is designed to be smaller, such as 0.8 mm. Such a design may help improve isolation and impedance matching.

In addition, as shown in FIG. 10, in the embodiment, each of two second slots 138a has multiple widths. Specifically, the widths of the second slot 138a are greater at positions S5 and S6, smaller at positions S6 and S7, and smaller at positions S6 and S8.

In the embodiment, referring to the first radiator 121 on the left of FIG. 9, the first feed end F1 is connected to the positions M1, M2, and N5 to couple the signal to the second slot 138 (at the positions S5 to S8) partially overlapping with the first slots 128a and 128b to excite Wi-Fi 6E/7, so as to have broadband antenna characteristics in the frequency bands of 2400 MHz to 2500 MHz (a first mode of Wi-Fi 6E/7) and 5150 MHz to 7125 MHz (a synthesized second mode and third mode of Wi-Fi 6E/7).

A path between the first feed end F1 and the position M1 is used to excite the first mode of Wi-Fi 6E/7. The horizontal length of the second slot 138 at the positions S6 and S7 and the positions S6 and S8 may adjust a resonant frequency point, such as 13 mm, of the second mode of Wi-Fi 6E/7. The length of the second slot 138 at the positions S5 and S6 may adjust the impedance matching, such as 6 mm, of the second mode of Wi-Fi 6E/7. The path length of the first feed end F1 and the positions M2 to N5 may be used to adjust the impedance matching, such as 6 mm, of the third mode of Wi-Fi 6E/7.

It should be noted that the second radiator 131 of FIG. 10 is the same as the second radiator 131 of FIG. 4 and will not be described in detail. Therefore, the following relationship between frequency and VSWR or antenna efficiency only discusses the relationship between frequency and VSWR or antenna efficiency of the two first radiators 121 and the decoupling element 127 in FIG. 9 and FIG. 10.

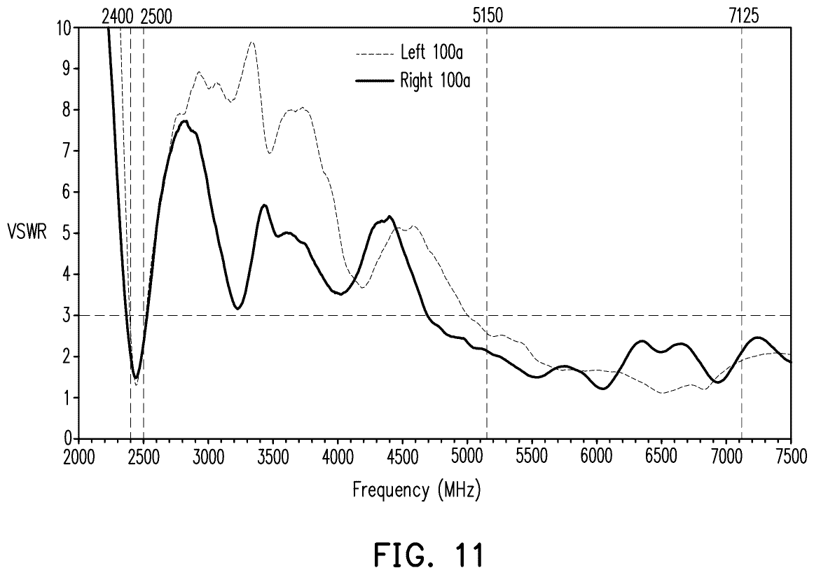

FIG. 11 is a frequency-VSWR relationship diagram of the electronic device of FIG. 1 adopting the antenna assemblies of FIG. 9 and FIG. 10 in left and right temples. Please refer to FIG. 11. Voltage standing wave ratios (VSWR) of the antenna assembly 100a of the left temple 12 and the antenna assembly 100a of the right temple 12 in the frequency bands of 2400 MHz to 2500 MHz and 5150 MHz to 7125 MHz may all be below 3 to have a good performance.

In addition, since there is a certain distance between the two first radiators 121 of the antenna assembly 100, and the decoupling element 127 is disposed between the two first radiators 121, the isolation performance is above 10 dB under broadband conditions. The envelope correlation coefficient (ECC) is below 0.15 to have a good performance.

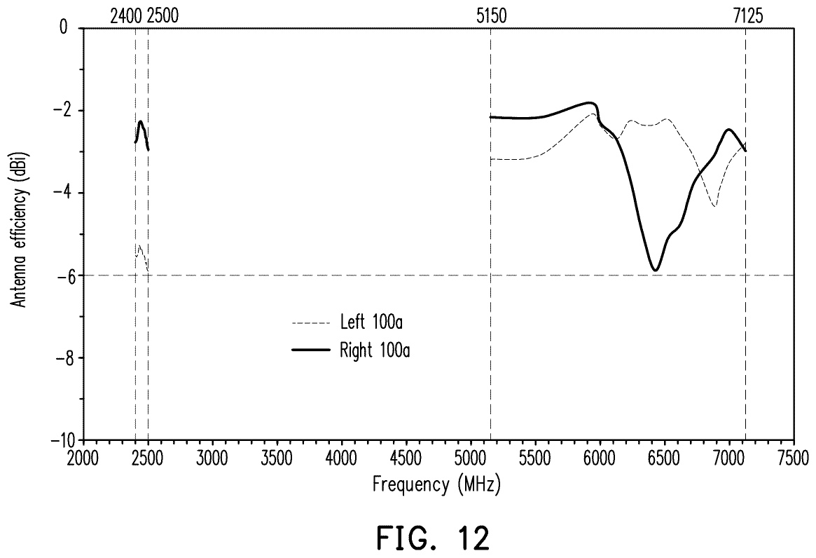

FIG. 12 is a frequency-antenna efficiency relationship diagram of the electronic device of FIG. 1 adopting the antenna assemblies of FIG. 9 and FIG. 10 in the left and right temples. Please refer to FIG. 12. Average antenna efficiencies of the antenna assembly 100 of the left temple 12 and the antenna assembly 100 of the right temple 12 are all above −6 dBi at 2400 MHz to 2500 MHz and 5150 MHz to 7125 MHz to have the characteristics of broadband and good antenna efficiency.

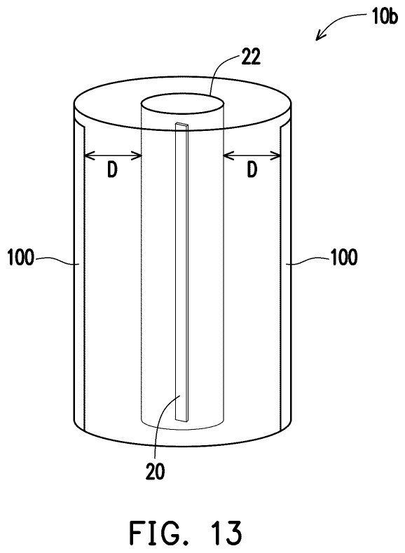

FIG. 13 is a schematic diagram of an electronic device according to another embodiment of the disclosure. Please refer to FIG. 13. In the embodiment, an electronic device 10b is, for example, a smart speaker. The electronic device 10b further includes a motherboard 20 and a metal shielding member 22 separating the motherboard 20 and the at least one antenna assembly 100. The metal shielding member 22 is used to block interference sources on the motherboard 20. A distance D between each antenna assembly 100 and the metal shielding member 22 is greater than 15 mm, which is approximately ⅛ of the wavelength of 2.4 G to better reduce the degree to which the interference sources on the motherboard 20 affect the quality of wireless reception.

In the embodiment, the number of the antenna assemblies 100 may be two, and in other embodiments, the number of the antenna assemblies 100 may be four, but not limited thereto. In the embodiment, the electronic device 10b is provided with multiple antenna assemblies 100 to have multi-antenna abilities, which effectively improves the spectrum efficiency of a wireless communication system, increases the transmission rate, and improves the communication quality.

In summary, the antenna assembly of the electronic device of the disclosure has a small size and can provide multi-band effects by the above configuration.

What is claimed is:

1. An electronic device, comprising:
at least one antenna assembly, each comprising:
a substrate, having a first surface and a second surface opposite to each other;
two first radiators, disposed on the first surface, each comprising a first feed end, and each adapted to operate in a high frequency band;
a decoupling element, disposed on the first surface, located between the two first radiators, and having a first slot with each of the first radiators;
a second radiator, disposed on the second surface, comprising a second feed end, and adapted to operate in a low frequency band and a medium frequency band; and
a ground plane, disposed on the second surface.

2. The electronic device according to claim 1, wherein the ground plane comprises two second slots, a projection of each of the two first radiators onto the ground plane partially overlaps with the corresponding second slot, and the two first radiators are conducted to the ground plane.

3. The electronic device according to claim 2, wherein each of the two first radiators comprises a first section, a second section, and a third section, the first section extends from the first feed end toward a direction of the other first radiator, the second section and the third section extend toward opposite directions, the third section has a first ground end, and the first ground end is conducted to the ground plane through a via.

4. The electronic device according to claim 3, wherein an outer contour of the decoupling element corresponds to an outer contour of the first section and the second section of each of the two first radiators, so that the first slot is formed between the decoupling element and the corresponding first section and second section.

5. The electronic device according to claim 3, wherein the two first radiators are in two T-shapes opposite to each other.

6. The electronic device according to claim 3, wherein widths of the two first slots are the same, and each of the two second slots has a single width.

7. The electronic device according to claim 3, wherein each of the two first radiators further comprises a fourth section extending from the second section toward a direction away from the other first radiator, and each of the two second slots has a plurality of widths.

8. The electronic device according to claim 7, wherein widths of the two first slots are between 0.8 mm and 2 mm, and the widths of the two first slots are different.

9. The electronic device according to claim 1, wherein the second radiator comprises a fifth section, a sixth section, a seventh section, and an eighth section which are sequentially bendingly connected, the second feed end is located at the fifth section and is close to the ground plane, the eighth section is parallel to the fifth section, the sixth section is parallel to the seventh section to form an L-shaped slot, and the eighth section is connected to the ground plane through a second ground end.

10. The electronic device according to claim 9, wherein each of the at least one antenna assembly comprises a matching circuit connected to the second feed end, and the eighth section is provided with an inductance element.

11. The electronic device according to claim 1, wherein the electronic device is glasses, the electronic device further comprises two temples, the at least one antenna assembly comprises two antenna assemblies, each of the two temples comprises a crossbar area and an ear hook area, the two first radiators, the decoupling element, and the ground plane of each of the two antenna assemblies are located in the corresponding crossbar area, and the second radiator of each of the two antenna assemblies is located in the corresponding ear hook area.

12. The electronic device according to claim 1, wherein the electronic device is a smart speaker, the electronic device further comprises a motherboard and a metal shielding member separating the motherboard and the at least one antenna assembly, and a distance between the at least one antenna assembly and the metal shielding member is greater than 15 mm.
